(19) United States
(12) Patent Application Publication
(10) Pub. No.: US 2019/0095024 A1
(43) Pub. Date: Mar. 28, 2019

(54) PRESSURE SENSING DEVICE AND ELECTRONIC APPARATUS HAVING SAME

(71) Applicant: SHENZHEN NEW DEGREE TECHNOLOGY CO., LTD., Shenzhen, Guangdong (CN)

(72) Inventor: Hao LI, Shenzhen, Guangdong (CN)

(21) Appl. No.: 16/075,859

(22) PCT Filed: Feb. 4, 2016
(86) PCT No.: PCT/CN2016/073572

§ 371 Date: Dec. 13, 2018

(51) Int. Cl. G06F 3/041

(52) U.S. Cl. CPC G06F 3/0414; G06F 2203/04106; G06F 3/0412

(57) ABSTRACT

The displacement sensor and the second panel maintain a certain distance, when the pressing force acts on the first panel, the first panel is bent deformation by the constraint of the supporting wall of the second panel, at this time the displacement sensor is connected to the first panel and follows the deflection deformation. The deflection deformation of the first panel causes the plane in which the displacement sensor is located to cause a change in the length of the dimension after bending, and the displacement sensor measures the change in the length of the dimension to obtain the magnitude of the pressure. The pressure sensing device and the electronic apparatus having the pressure sensing device are easy to process, have good tolerance to the environment, are not easily changed by external impacts, and provide accurate pressure measurement.

### TECHNICAL FIELD

The present application relates to the technical field of pressure sensing, and more particularly to a pressure sensing device and electronic apparatus having same.

### BACKGROUND

There are many different types of pressure sensing devices, including strain gauge type, capacitive type, inductive type, and resistive type. The principle of capacitive type, inductive type and partially resistive type pressure sensing devices are based on the change in relative displacement between two layers of panels to produce a change in capacitance, inductance or resistance. These pressure sensing devices have the problems of high requirement on processing precision, low environmental tolerance, and unstable baseline parameters, due to external impacts, resulting in inaccurate pressure measurement.

### SUMMARY

An object of the present application is to provide a pressure sensing device, in order to solve the problem that the present pressure sensing devices have the problems of high requirement on processing precision, low environmental tolerance, and unstable baseline parameters due to external impacts, resulting in inaccurate pressure measurement.

The present application is achieved in such a manner that a pressure sensing device comprises:

a first panel;

a second panel spaced apart from the first panel, the second panel is provided with a supporting wall at an edge of one side facing towards the first panel, the first panel and the second panel are connected by the supporting wall; and

a displacement sensor spaced apart from the second panel, the displacement sensor comprises a substrate connected to an inner side of the first panel and a strain sensing element disposed at the substrate and used for measuring a deflection deformation of the first panel being pressed.

Further, the number of the strain sensing element is one; or the number of the strain sensing elements is at least two, and all of the strain sensing elements are annularly distributed on the substrate; or the number of the strain sensing elements is at least two, and all of the strain sensing elements are distributed in an array on the substrate.

Further, the substrate has a top side and a bottom side distributed relative to each other along a length direction thereof, and the strain sensing element is divided into a first strain sensing unit and a second strain sensing unit, and the displacement sensor has a bridge circuit composed of two first strain sensing units and two second strain sensing units, the two first strain sensing units are distributed near the top side of the substrate, and the two second strain sensing units are distributed near the bottom side of the substrate;

alternatively, the substrate has two sides relatively distributed along the width direction thereof, the substrate is formed with a central axis region between the two sides, and the strain sensing element is divided into a first strain sensing unit and a second strain sensing unit, the displacement sensor has a bridge circuit composed of two first strain sensing units and two second strain sensing units, and the two first strain sensing units are distributed at the central axis region of the substrate, the two second strain sensing units are distributed near one of the sides of the substrate.

Further, the number of the bridge circuits is at least one, and two of the first strain sensing units and two of the second strain sensing units in each of the bridge circuits are arranged in an array.

Further, the number of the bridge circuits is at least two, and the substrate is formed a spacer region between the first strain sensing unit and the second strain sensing unit in the closest distance of one of the bridge circuits, the spacer region is distributed at least one of the first strain sensing unit of the other of the bridge circuits.

Further, the substrate has a first side surface and a second side surface relatively distributed along a thickness direction thereof, and the strain sensing element is divided into a first strain sensing unit and a second strain sensing unit, and the displacement sensor has a bridge circuit composed of two first strain sensing units and two second strain sensing units, two the first strain sensing units are distributed on the first side, and two the second strain sensing units are distributed on the second side.

Further, the first panel is a touch panel, a display panel, a steel plate, a glass plate or a PC board.

Further, the first panel and the displacement sensor are connected by a first adhesive.

Further, the first panel is connected to the supporting wall away from an end of the second panel by a second adhesive.

Further, a third panel is sandwiched between the first panel and the displacement sensor.

Further, the third panel and the displacement sensor are connected by a first adhesive.

Further, the third panel is an OLED display screen, an LCD display screen, an EL luminescent panel or a light guiding panel.

Further, a buffer member is disposed between a side of the displacement sensor facing the second panel and the second panel.

Further, the buffer member has a plate shape, and the buffer member is provided with a receiving groove for receiving the strain sensing element; or the buffer member has a column shape, and the buffer member is staggered from the strain sensing element.

Another object of the present application is to provide an electronic apparatus comprising a pressure sensing device described herein and a peripheral processing circuit electrically connected to the displacement sensor.

Compared to the prior art, the technical effect of the present application is that the displacement sensor and the second panel maintain a certain distance, when the pressing force acts on the first panel, the first panel is bent by the constraint of the supporting wall of the second panel, at this time the displacement sensor is connected to the first panel and follows the deflection deformation. The deflection deformation of the first panel causes the plane in which the displacement sensor is located to change in the length of the dimension after deflection, and the displacement sensor measures the change in the length of the dimension to obtain the magnitude of the pressure. The pressure sensing devices and the electronic apparatus having the pressure sensing device described herein are easy to process, have good tolerance to the environment, are not easily changed by external impacts, and provide accurate pressure measurement.

### BRIEF DESCRIPTION OF THE DRAWINGS

FIG. 1 is a schematic structural view of a pressure sensing device according to a first embodiment of the present application;

FIG. 2 is a front view of the displacement sensor applied in the pressure sensing device of FIG. 1;

FIG. 3 is a front view of a displacement sensor applied in a pressure sensing device according to a second embodiment of the present application;

FIG. 4 is a schematic view of a bridge circuit of a displacement sensor applied in the pressure sensing device of FIG. 3;

FIG. 5 is a front view of a displacement sensor applied in a pressure sensing device according to a third embodiment of the present application;

FIG. 6 is a side view of a displacement sensor applied in a pressure sensing device according to a fourth embodiment of the present application;

FIG. 7 is a schematic structural view of a pressure sensing device according to a fifth embodiment of the present application;

FIG. 8 is a schematic structural view of a pressure sensing device according to a sixth embodiment of the present application;

FIG. 9 is a schematic view showing the assembly of the buffer member and the displacement sensor applied to the pressure sensing device of FIG. 8;

FIG. 10 is a schematic structural view of a pressure sensing device according to a seventh embodiment of the present application.

In the drawings, the following reference numerals are used:
first panel 10, side 31c, first adhesive 41;
second panel 20, central axis region 31d, second adhesive 42;
supporting wall 21, first side surface 31e, third panel 50;
displacement sensor 30, second side surface 31f, buffer member 60;
base board 31, wire 32, receiving groove 61;
top side 31a, first strain sensing unit R1, R2;
bottom side 31b, second strain sensing unit R3, R4.

### DETAILED DESCRIPTION OF THE EMBODIMENTS

In order to make the purpose, technical solutions, and beneficial effects of the present application clearer and more understandable, the present application will be further described in detail herein after with reference to the accompanying drawings and embodiments. It should be understood that the embodiments described herein are only intended to illustrate but not to limit the present application.

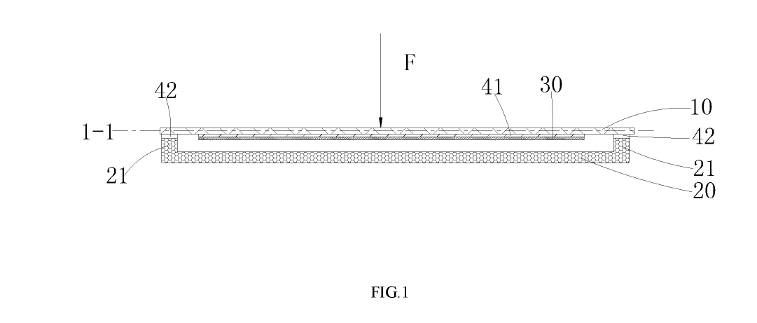

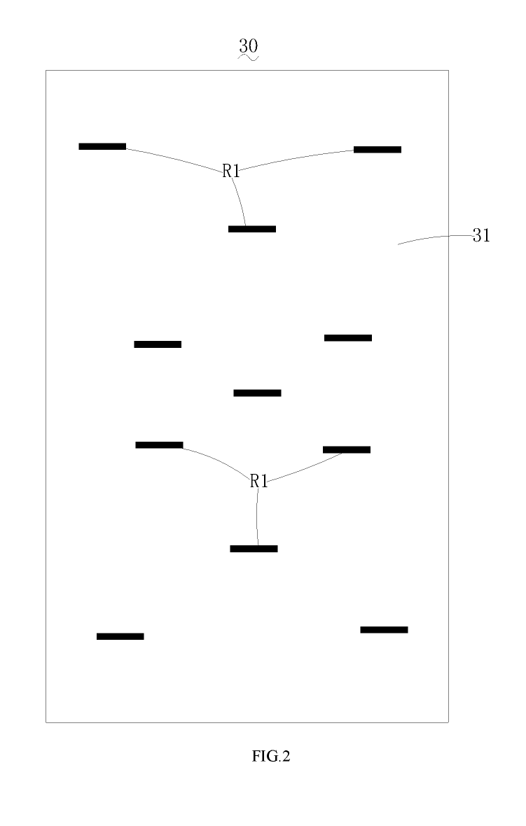

Please refer to FIG. 1 and FIG. 2, a pressure sensing device according to a first embodiment of the present application includes:

first panel 10;

a second panel 20 spaced apart from the first pane 101, the second panel 20 is provided with a supporting wall 21 at an edge of one side facing towards the first panel 10, the first panel 10 and the second panel 20 are connected by the supporting wall 21; and

a displacement sensor 30 spaced apart from the second panel 20, the displacement sensor 30 comprises a substrate 31 connected to an inner side of the first panel 10 and a strain sensing element R1 disposed at the substrate 31 and used for measuring a deflection deformation when the first panel 10 is pressed.

The displacement sensor 30 and the second panel 20 maintain a certain distance, when the pressing force acts on the first panel 10, the first panel 10 is bent deformation by the constraint of the supporting wall 21 of the second panel 20, at this time the displacement sensor 30 is connected to the first panel 10 and follows the deflection deformation. The deflection deformation of the first panel 10 causes the plane in which the displacement sensor 30 is located to cause a change in the length of the dimension after deflection, and the displacement sensor 30 measures the change in the length of the dimension to obtain the magnitude of the pressure. The pressure sensing device and the electronic apparatus having the pressure sensing device are easy to process, have good tolerance to the environment, are not easily changed by external impacts, and provide accurate pressure measurement.

Specifically, the supporting wall 21 may be integrally formed on the second panel 20, or the supporting wall 21 may be assembled on the second panel 20. Two or more supporting walls 21 are distributed on the second panel 20 in the width direction of the substrate 31. The supporting wall 21 of the second panel 20 is used for maintain the fixing of the first panel 10, and the two supporting walls 21 simultaneously restrain the first panel 10 at the left and right positions, when the first panel 10 is pressed, the first panel 10 occurs deflection deformation due to the restrain of the supporting wall 21.

The displacement sensor 30 has a film shape, and the displacement sensor 30 is laminated with the first panel 10, which is compact and easy to install. The strain sensing element R1 is taken out by the wires and collected on the peripheral processing circuit, The peripheral processing circuit receives the electric signal generated by the strain sensing element R1 and calculates the magnitude of the pressing pressure, or even the pressed position, which is a prior art. The strain sensing component can be a varistor, a strain gauge, an Force Sensing Resistor (FSR) resistive pressure sensor or other strain sensing component.

The displacement sensor 30 is maintained a certain distance from the second panel 20. This distance depends on the physical dimensions and Young's modulus of the first panel 10 (and the associated third panel described below) and the amount of operating pressure that the first panel 10 surface is allowed to withstand.

The amount of deflection deformation of the first panel 10 depends on the physical dimensions of the first panel 10, the Young's modulus of the first panel 10, the connection between the first panel 10 and the displacement sensor 30 (such as the first adhesive 41 described below), and the physical dimensions of the substrate 31 that the displacement sensor 30 is located and the Young's modulus of the material. However, for a given first panel 10, the deformation of the first panel 10 primarily depends on the position and magnitude of the force acted on the surface of the first panel 10.

Further, the number of the strain sensing elements R1 is one; or the number of the strain sensing elements R1 is at least two, and all the strain sensing elements R1 are annularly distributed on the substrate 31; or the number of the strain sensing elements R1 is at least two, and all the strain sensing elements R1 are distributed in an array on the substrate 31. In the above scheme, when the pressure is applied to the first panel 10, at least one strain sensing element follows the deflection deformation of the first panel 10 to generate a measurement signal, and the amount of deflection deformation of the first panel 10 is measured. The number of strain sensing elements may vary depends on the physical dimension of the first panel 10. The strain sensing elements are evenly distributed on the substrate 31, and may be appropriately distributed according to the mathematical simulation of the first panel 10. Each of the distribution schemes corresponds to a pressure calculation formula, and a plurality sets of electrical signals generated by deflection deformation of the first panel 10 are obtained by a plurality of strain sensing elements, and the distribution, dimension and other characteristics of the electrical signals are analyzed, and by pressure calculation formula calculates the position and dimension of the pressing force pressed on the first panel 10, which is a prior art. If the first panel 10 can also provide an accurate pressing position signal, then a more accurate measurement of the pressing force can be obtained on this basis.

Further, the first panel 10 is a touch panel, a display panel, a steel plate, a glass plate, or a PC board. The touch panel can be a resistive, capacitive or other form of touch screen that can provide positional information for the press, at which point the displacement sensor 30 only provides pressure information. The first panel 10 can also be a piece of plate, such as a steel plate, a glass plate or a PC board. At this time, the displacement sensor 30 can provide pressure information and certain positional information as needed.

Further, the first panel 10 and the displacement sensor 30 are connected by a first adhesive 41. The displacement sensor 30 is adhered to the first panel 10 by the first adhesive 41, which is easily assembled, and a small deformation caused by the pressure of the first panel 10 is easily transmitted to the displacement sensor 30. It can be understood that the fixed connection between the first panel 10 and the displacement sensor 30 can also be achieved by welding or other mechanical connection.

Further, the first panel 10 is connected to an end of the supporting wall 21 away from the second panel 20 by the second adhesive 42. The second panel 42 is fixedly connected between the first panel 10 and the supporting wall 21, which is easily assembled and firmly connected. It can be understood that the first panel 10 and the supporting wall 21 can also be fixedly connected by welding or other mechanical connection.

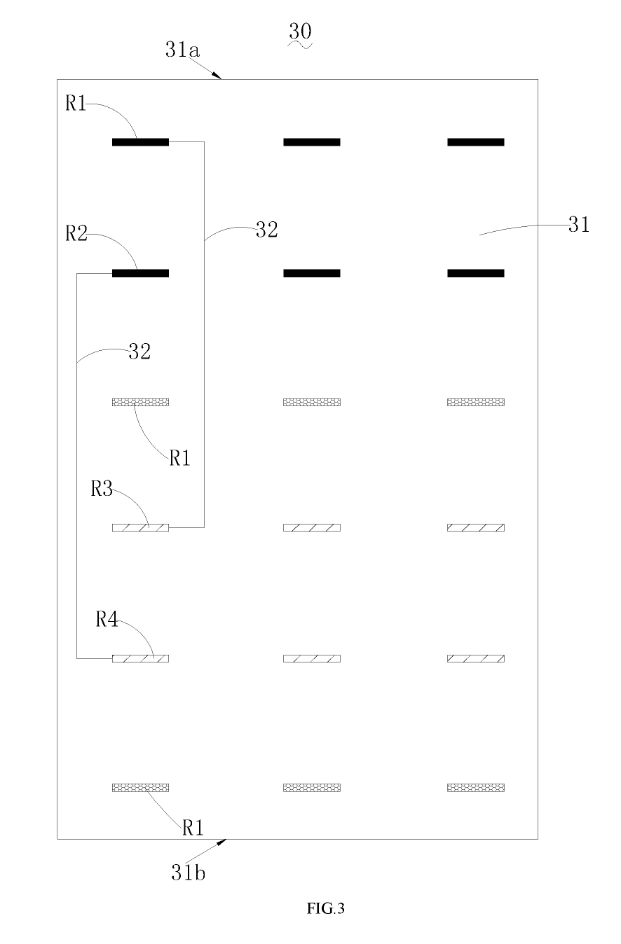

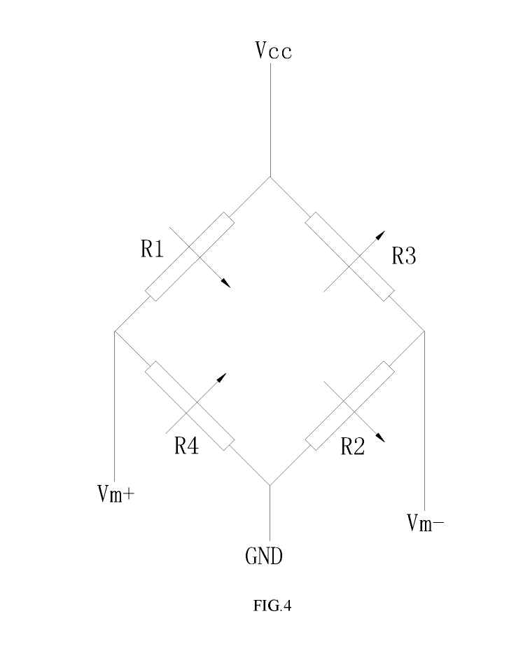

Please refer to FIG. 3 and FIG. 4, the pressure sensing device provided by the second embodiment of the present application is substantially the same as the pressure sensing device provided by the first embodiment, unlike the first embodiment, the substrate 31 has a top side 31a and a bottom side 31b are oppositely distributed in the longitudinal direction thereof, and the strain sensing element is divided into a first strain sensing unit (R1, R2) and a second strain sensing unit (R3, R4), and the displacement sensor 30 has a bridge circuit composed of two first strain sensing unit (R1, R2) and two second strain sensing units (R3, R4), the two first strain sensing units are distributed near the top side 31a of the substrate 31, two the two strain sensing units are distributed near the bottom side 31b of the substrate 31.

In the bridge circuit composed of the first strain sensing resistors R1 and R2 and the second strain sensing resistors R3 and R4, inputting a voltage Ui, and an output voltage Uo is obtained at both ends of Vm+ and Vm−,

$${U}_{o} = \frac{{R}_{1} {R}_{2} - {R}_{3} {R}_{4}}{( {R}_{1} + {R}_{4} ) ( {R}_{2} + {R}_{3} )} {U}_{i}$$

and there are an input and output voltage formulas:

Since the resistance values of the first strain sensing unit and the second strain sensing unit are changed according to the deformation, it is necessary to make the two strain sensing units have different deformations in order to obtain different changes in the resistance values of the two sets. When the first panel 10 is pressed, the first strain sensing unit and the second strain sensing unit will be deformed along with the deformation of the first panel 10, where the spatial positions on the first panel 10 are similar, the deformation amount are similar, therefore, the first strain sensing units R1 and R2 and the second strain sensing units R3 and R4 must be placed far apart for differently deforming.

The first strain sensing units R1 and R2 are distributed near the top side 31a of the first panel 10, and the second strain sensing units R3 and R4 are distributed near the bottom side 31b of the first panel 10. If the first strain sensing unit R1 and R2 change greatly as being pressed near the top side 31a of the first panel 10, as the measuring sensor, and the second strain sensing units R3 and R4 are unchanged or changed little, as a reference sensor, and further the output voltage Uo is obtained as an output signal. If the bottom side 31b close to the first panel 10 is pressed, the change is reversed, and the output voltage Uo can also be obtained as an output signal. The functions of the measuring sensor and the reference sensor can be converted to each other and are not limited to measurement or reference only.

In a bridge circuit, the first strain sensing units R1, R2 and the second strain sensing units R3, R4 are distributed at different positions corresponding to the first panel 10, and maintain a certain distance from each other. Specifically, the distance is greater than 36 mm. The first strain sensing units R1, R2 and the second strain sensing units R3, R4 are connected to each other by a wire 32 to form a bridge circuit.

When a force is applied to the first panel 10, the plurality sets of bridge circuits can obtain the corresponding electrical signals, and the electrical signals can accurately calculate the strength of the force by combining the pressing position information given by the first panel 10. In this process, the functions of the first strain sensing units R1, R2 and the second strain sensing units R3, R4 as measuring sensors or reference sensors are converted at any time.

Further, the number of the bridge circuits is at least one, and the two first strain sensing units and the two second strain sensing units in each of the bridge circuits are arranged in an array. This configuration makes it easy to distribute the strain sensing element. Specifically, the two first strain sensing units R1 and R2 and the two second strain sensing units R3 and R4 are distributed in an array and have a compact structure. Also, when a plurality of bridge circuits are arranged, the strain sensing elements of the plurality of bridge circuits may be arranged in an array, and the structure is compact.

A plurality of sets of electrical signals generated by deflection deformation of the first panel 10 are obtained by a plurality of bridge circuits, and the distribution, dimension and other characteristics of the electrical signals are analyzed to calculate and obtain the distribution and dimension of the force pressed on the first panel 10. If the first panel 10 can also provide an accurate pressing position signal, then a more accurate measurement of the pressing force can be obtained on this basis.

Further, the number of the bridge circuits is at least two, and the substrate 31 has a spacer region formed between the first strain sensing unit and the second strain sensing unit in the closest one of the bridge circuits, and at least one first strain sensing unit of the other bridge circuit is distributed on the spacer region. The plurality of sensors of the plurality of bridge circuits are staggered and the structure is compact, and the distance between the first strain sensing unit and the second strain sensing unit in one bridge circuit is relatively far.

Please refer to FIG. 5, a pressure sensing device according to a third embodiment of the present application is substantially the same as the pressure sensing device provided in the second embodiment, unlike the second embodiment, the substrate 31 has two sides 31c are oppositely distributed along a width direction thereof, the substrate 31 is formed with a central axis region 31d between the two sides 31c, and the strain sensing element is divided into a first strain sensing unit (R1, R2) and a second strain sensing unit (R3, R4), the displacement sensor 30 has a bridge circuit composed of two first strain sensing units (R1, R2) and two second strain sensing units (R3, R4), and the two first strain sensing units are distributed in the central axis region 31d of the substrate 31, the two second strain sensing units are distributed close to one of the sides 31c of the substrate 31.

The principle of the bridge circuit can be referred to the second embodiment. Specifically, the first strain sensing units R1, R2 are distributed as the measuring sensors in the central axis region 31d of the first panel 10, and the second strain sensing units R3, R4 are distributed as reference sensors in the vicinity of the first panel 10 near the sides 31c. It can be seen from the mathematical simulation calculation that around the vicinity of the side 31c of the first panel 10, regardless of the force located at any position of the first panel 10, the position appears to be relatively curved deformation relative to other positions, including the center position. The measuring sensor and the reference sensor are connected to each other by a wire 32 and together constitute a bridge circuit. In the measurement, the difference between the test data of the measurement sensor and the reference sensor is obtained, and output to the peripheral processing circuit, and combined with the information of the pressing position given by the first panel 10, the accurate pressing force can be obtained.

Further, the number of the bridge circuits is at least one, and the two first strain sensing units and the two second strain sensing units in each of the bridge circuits are arranged in an array. This configuration makes it easy to distribute the strain sensing element. Specifically, the two first strain sensing units R1, R2 and the two second strain sensing units R3, R4 are distributed in four rectangular end points and have a compact structure. Also, when a plurality of bridge circuits are arranged, the strain sensing elements of the plurality of bridge circuits may be arranged in an array, and the structure is compact.

Further, the number of the bridge circuits is at least two, and the substrate 31 has a spacer region formed between the first strain sensing unit and the second strain sensing unit in the closest one of the bridge circuits, and at least one first strain sensing unit of the other bridge circuit is distributed on the spacer region. The plurality of sensors of the plurality of bridge circuits are staggered and the structure is compact, and the distance between the first strain sensing unit and the second strain sensing unit in one bridge circuit is relatively far.

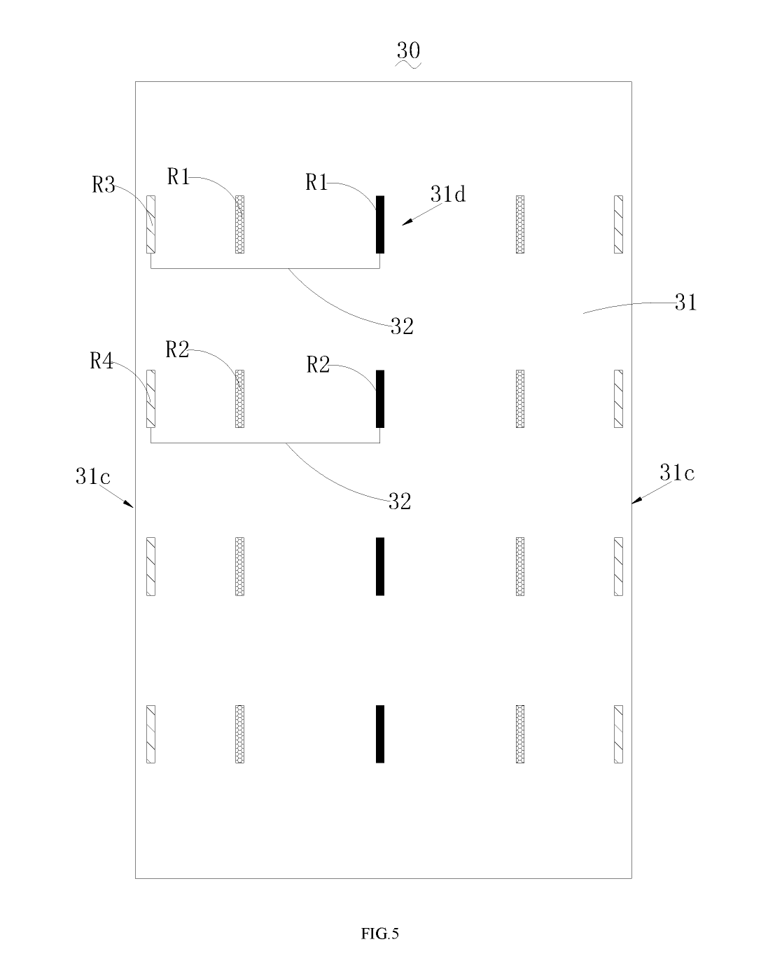

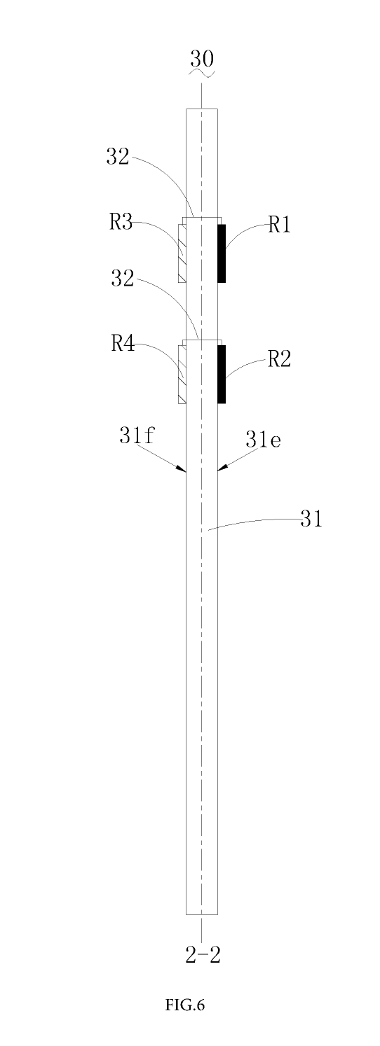

Please refer to FIG. 6, a pressure sensing device according to a fourth embodiment of the present application is substantially the same as the pressure sensing device provided in the second embodiment, unlike the second embodiment, the substrate 31 has a first side surface 31e and a second side surface 31f are oppositely distributed along the its thickness direction, the strain sensing element is divided into a first strain sensing unit (R1, R2) and a second strain sensing unit (R3, R4), and the displacement sensor 30 has a bridge circuit composed of two first strain sensing units (R1, R2) and two second strain sensing units (R3, R4), two first strain sensing units are distributed on the first side 31e, and two second strain sensing units are distributed on the second side 31f.

The principle of the bridge circuit can be referred to the second embodiment. Specifically, the first strain sensing units R1, R2 are distributed as measuring sensors on a side of the substrate 31 facing the first panel; the second strain sensing units R3, R4 are distributed as reference sensors on a side of the substrate 31 away from the first panel. At this time, all of the measurement sensors are distributed on one side of the substrate 31, and all of the reference sensors are distributed on the other side of the substrate 31. The first strain sensing units R1, R2 and the second strain sensing units R3, R4 are connected to each other by a wire 32 and together constitute a bridge circuit. The displacement sensor 30 has one or more sets of bridge circuits. When the pressing force is applied to the first panel, the first panel is bent and deformed based on the center line 1-1 of the first panel, while being specific to the displacement sensor 30, the substrate 31 of the displacement sensor 30 is bent and deformed based on the center line 2-2 of the substrate 31. At the position of the center line 2-2, the dimensional length of the substrate 31 does not change after the substrate 31 is bent and deformed, and the surface of the substrate 31 which is in conformity with the deflection direction becomes larger in dimensional length and at the same time the surface the substrate 31 away from the deflection direction becomes smaller in dimensional length. The signal difference between two functions of the sensors is obtained by the first strain sensing units R1 and R2 and the second strain sensing units R3 and R4 distributed on both sides of the substrate 31, outputted to the peripheral processing circuit, and in combination with the given position signal of the first panel can obtain the exact pressing force.

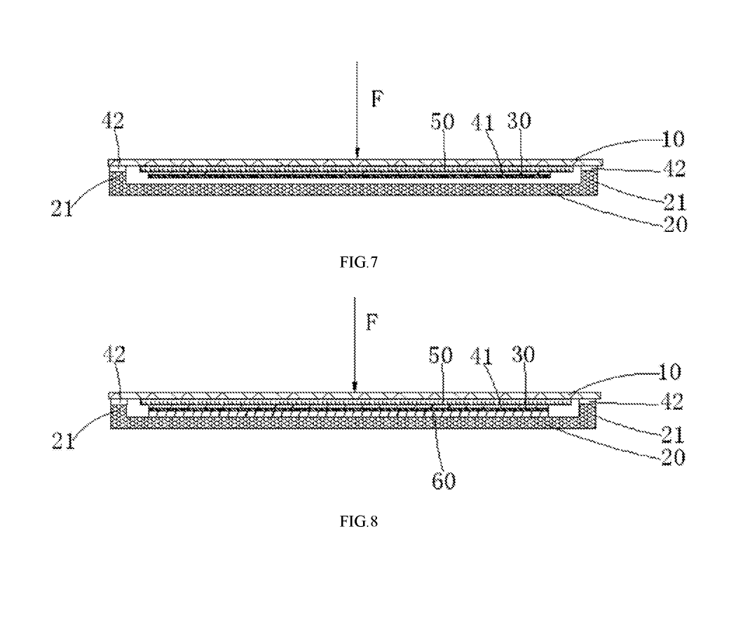

Please refer to FIG. 7, a pressure sensing device according to a fifth embodiment of the present application is substantially the same as the pressure sensing device provided in the first embodiment, unlike the first embodiment, a third panel 50 is sandwiched between the first panel 10 and the displacement sensor 30. Realizing Integration with input control devices referring to existing screen and device.

Further, the third panel 50 and the displacement sensor 30 are connected by a first adhesive 41. The displacement sensor 30 is bonded to the third panel 50 by the third adhesive, which is easily assembled, and the small deformation caused by the pressure of the first panel 10 is easily transmitted to the displacement sensor 30 through the third panel 50.

Further, the third panel 50 is an OLED display screen, a LCD display screen, an EL luminescent panel or a light guiding panel. Which Realize integration with input control devices referring to existing screen and device. The LCD display is a LCD laminate display screen. The third panel 50 can also be other light emitting panels. Specifically, the first panel 10 is a 0.8 mm thick glass panel, the third panel 50 is a 0.76 mm thick OLED display panel, the displacement sensor 30 has thickness of 0.1 mm, and the distance between the displacement sensor 30 and the second panel 20 is 0.4. mm.

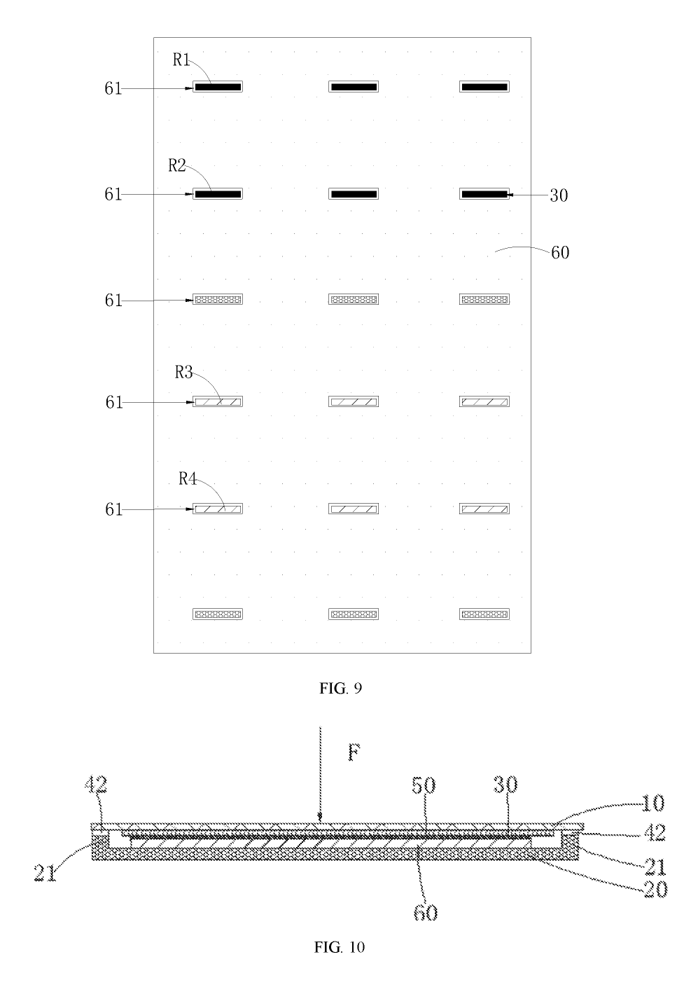

Please refer to FIG. 8 and FIG. 9, the pressure sensing device provided by the sixth embodiment of the present application is substantially the same as the pressure sensing device provided by the second embodiment, unlike the second embodiment,

a buffer member 60 is disposed between a side of the displacement sensor 30 facing the second panel 20 and the second panel 20. The buffer member 60 is filled between the displacement sensor 30 and the second panel 20. The buffer member 60 may be a compressible foam rubber such as acrylic foam cotton having a compression ratio of 85%, the buffer member 60 is bonded to the displacement sensor 30 by self-adhesive glue. The buffer member 60 can also be filled with compressed air or insulating oil. The buffer member 60 should satisfy with good compressibility and flow properties and does not prevent deformation of the first panel 10. The function of the buffer member 60 is to buffer the displacement of the displacement sensor 30 caused by the deformation of the second panel 20, to buffer the severe deformation of the first panel 10, and to protect the first panel 10 and the third panel 50 from destruction and so on by external impact.

Further, the buffer member 60 has a plate shape, and the buffer member 60 is provided with a receiving groove 61 for receiving the strain sensing elements (R1, R2, R3, R4). The buffer member 60 has a certain area size, and the buffer member 60 performs the avoidance treatment at the position of the strain sensing element produced by the displacement sensor 30. That is, a hole site of the receiving groove 61 provided by the buffer member 60 at the position of the strain sensing element should be greater than or equal to the outer dimension of the strain sensing element. But the outer diameter of the hole site of the buffer member 60 should not be larger than twice the size of the strain sensing element. The hole site of the buffer member 60 is such that the strain sensing element follows the deflection deformation of the displacement sensor 30 without being hindered, and the influence of the deformation of the second panel 20 to the strain sensing element is minimized.

Alternatively, the buffer member has a columnar shape, and the buffer member is staggered with the strain sensing element. Specifically, the buffer member is a PE foamed cotton having a diameter of 10 mm; the buffer member is bonded to the displacement sensor by self-adhesive glue, and avoiding the position of the strain sensing element (R1, R2, R3, R4), which is disposed on the center of the physical location of the displacement sensor, or evenly arranged according to the central area. The number of buffer members are configured as needed.

Please refer to FIG. 10, a pressure sensing device according to a seventh embodiment of the present application is substantially the same as the pressure sensing device provided in the sixth embodiment, unlike the sixth embodiment, there is no first adhesive disposed between the first panel 10 and the displacement sensor 30, but a buffer member 60 is disposed between a side of the displacement sensor 30 facing the second panel 20 and the second panel 20, and the first panel 10 and the second panel 20 are fixed by the supporting wall 21, the displacement sensor 30 is urged toward the first panel 10 by the buffer member 60, so that the small deformation caused by the pressure of the first panel 10 is transmitted to the displacement sensor 30.

Please refer to FIG. 1 and FIG. 2, an electronic apparatus according to an embodiment of the present application includes a pressure sensing device and a peripheral processing circuit electrically connected to the displacement sensor 30. The peripheral processing circuit includes a processing chip or the like, and the peripheral processing circuit receives the electrical signal generated by the strain sensing element and calculates the magnitude of the pressing pressure, or even the pressed position, which is a prior art.

The displacement sensor 30 and the second panel 20 maintain a certain distance, when the pressing force acts on the first panel 10, the first panel 10 is bent deformation by the constraint of the supporting wall 21 of the second panel 20, at this time the displacement sensor 30 is connected to the first panel 10 and follows the deflection deformation. The deflection deformation of the first panel 10 causes the plane in which the displacement sensor 30 is located to cause a change in the length of the dimension after deflection, and the displacement sensor 30 measures the change in the length of the dimension to obtain the magnitude of the pressure. The pressure sensing device and the electronic apparatus having the pressure sensing device are easy to process, have good tolerance to the environment, are not easily changed by external impacts, and provide accurate pressure measurement.

The aforementioned embodiments are only preferred embodiments of the present application, and are not intended to limit the present application. Any modification, equivalent replacement, improvement, and so on, which are made within the spirit and the principle of the present application, should be included in the scope of the present utility model. Therefore, the scope of the present application is subject to the scope of the claims.

1. A pressure sensing device, comprising:
a first panel;
a second panel spaced apart from the first panel, the second panel is provided with a supporting wall at one or more edges of one side facing towards the first panel, the first panel and the second panel are connected via the supporting wall; and
a displacement sensor spaced apart from the second panel, the displacement sensor comprises a substrate connected to an inner side of the first panel and at least one strain sensing element disposed on the substrate and configured for measuring a deflection deformation of the first panel being pressed.

2. The pressure sensing device of claim 1, wherein the at least one strain sensing element comprises at least two strain sensing elements annularly distributed on the substrate or distributed in an array on the substrate.

3. The pressure sensing device of claim 1, wherein the substrate has a top side and a bottom side relatively distributed along a length direction thereof, and the at least one strain sensing element comprises a first strain sensing unit and a second strain sensing unit, and the displacement sensor has at least one bridge circuit each composed of two first strain sensing units and two second strain sensing units, the two first strain sensing units are distributed near the top side of the substrate, and the two second strain sensing units are distributed near the bottom side of the substrate.

4. The pressure sensing device of claim 3, wherein two of the first strain sensing units and two of the second strain sensing units in each of the at least one bridge circuit are arranged in an array.

5. The pressure sensing device of claim 4, wherein the at least one bridge circuit comprises at least two bridge circuits, and the substrate is formed a spacer region between the first strain sensing unit and the second strain sensing unit in the closest distance of one of the two bridge circuits, the spacer region is distributed at least one of the first strain sensing unit of the other one of the two bridge circuits.

6. The pressure sensing device of claim 1, wherein the substrate has a first side surface and a second side surface relatively distributed along a thickness direction thereof, and the at least one strain sensing element comprises a first strain sensing unit and a second strain sensing unit, and the displacement sensor has a bridge circuit composed of two first strain sensing units and two second strain sensing units, the two first strain sensing units are distributed on the first side, and the two second strain sensing units are distributed on the second side.

7. The pressure sensing device of claim 1, wherein the first panel is selected from a group consisting of a touch panel, a display panel, a steel plate, a glass plate and a PC board.

8. The pressure sensing device of claim 1, wherein the first panel and the displacement sensor are connected by a first adhesive.

9. The pressure sensing device of claim 1, wherein the first panel is connected to the supporting wall away from an end of the second panel by a second adhesive.

10. The pressure sensing device of claim 1, wherein a third panel is sandwiched between the first panel and the displacement sensor.

11. The pressure sensing device of claim 10, wherein the third panel and the displacement sensor are connected by a first adhesive.

12. The pressure sensing device of claim 10, wherein the third panel is an OLED display, a LCD display, an EL luminescent plate or a light guiding plate.

13. The pressure sensing device of claim 1, wherein a buffer member is disposed between the second panel and a side of the displacement sensor facing the second panel.

14. The pressure sensing device of claim 13, wherein the buffer member has a plate shape, and the buffer member is provided with a receiving groove for receiving the at least one strain sensing element.

15. An electronic device, comprising: a pressure sensing device of claim 1, and a peripheral processing circuit electrically connected to the displacement sensor.

16. The pressure sensing device of claim 1, wherein the substrate has two sides relatively distributed along the width direction thereof, the substrate is formed with a central axis region between the two sides, and the at least one strain sensing element comprises a first strain sensing unit and a second strain sensing unit, the displacement sensor has a bridge circuit composed of two first strain sensing units and two second strain sensing units, and the two first strain sensing units are distributed at the central axis region of the substrate, the two second strain sensing units are distributed near one of the sides of the substrate.

17. The pressure sensing device of claim 13, wherein the buffer member has a column shape, and the buffer member is in staggered distribution with the at least one strain sensing element.
